(19) United States
(12) Patent Application Publication
(10) Pub. No.: US 2025/0219484 A1
(43) Pub. Date: Jul. 3, 2025

(54) STATORLESS ELECTROMECHANICAL DEVICE AND METHOD THEREOF

(71) Applicant: Rohit Gadagkar, Bengaluru (IN)

(72) Inventor: Rohit Gadagkar, Bengaluru (IN)

(21) Appl. No.: 19/002,806

(22) Filed: Dec. 27, 2024

(30) Foreign Application Priority Data
Dec. 27, 2023 (IN) 202341089020

(51) Int. Cl. H02K 1/22; H02K 1/24; H02K 16/00

(52) U.S. Cl. CPC H02K 1/223; H02K 1/246; H02K 16/005; H02K 2201/12

(57) ABSTRACT

A statorless electromechanical device and a method thereof, are disclosed. The statorless electromechanical device comprises rotors. Each rotor is configured with a defined configuration of variable reluctance mechanism for inductive power transfer to receive electric current from a power source. Each rotor comprises toroidal rings, petal units, and a controller. The petal units comprise magnetic cores, non-magnetic sheets, pairs of magnets, and coils. The magnetic cores provide a flux path for guiding magnetic field to produce a unidirectional torque. The pairs of magnets generate the magnetic field. The coils carry a first force orthogonal to the magnetic field while conducting electric current for generating the unidirectional torque through a second force. The controller trigger activation and deactivation of defined petal units for controlling the generated unidirectional torque.

### EARLIEST PRIORITY DATE

This application claims priority from a Provisional patent application filed in India having Patent Application No. 202341089020, filed on Dec. 27, 2023, and titled “STATORLESS DIRECT CURRENT MOTOR AND GENERATOR”.

### TECHNICAL FIELD

Embodiments of the present disclosure relate to direct current electrical machines and more particularly relate to a statorless electromechanical device and a method thereof.

### BACKGROUND

Prior art electric motors used in Electric Vehicles (EV) and other applications are one of: mechanically commutated as in Brushed Direct Current (DC) motors, electrically commutated as in Induction and Synchronous motors, and electronically switched at high frequency as in Switched Reluctance Motors (SRM) and Brushless DC (BLDC) motors. Mechanical commutation is inefficient with inherent problems including sparking, heat, vibration and cogging, corrosion and has limited Revolutions Per minute (RPM). Synchronous and Induction motors generate high frequency 3-phase Alternating Current (AC) using specialised power inverters and Variable Frequency Drive (VFD) to create a high RPM rotating magnetic field (RMF) in stator one or more coils. This causes power factor losses requiring the use of bulky capacitor banks to increase usable power. The SRM and the BLDC motors employ high frequency inverter power electronics to switch two or more phases of coils with DC pulses by measuring rotor position using Hall effect sensors. These motors produce lower torque and suffer from cogging, vibrations, noise, and switching losses. The DC motors including variable speed BLDC use Pulse Width Modulation (PWM) to produce average DC voltage to control motor speed and torque thereby requiring specialised inverter power electronics for high frequency switching. This reduces efficiency apart from generating torque ripples, vibration, and noise.

Furthermore, the motors described above use variable high frequency inverters to reduce cogging and size of capacitors and inductors that are employed in filters and power factor correction circuitry. This necessitates the use of expensive electronic switching devices made from specialised materials such as silicon carbide (SiC) that may operate at high frequency and heat. Hysteresis in ferromagnetic cores and eddy currents in metallic materials including magnets, one or more rotors, motor shaft, casing, bearings and other structural parts resulting from high frequency alternating magnetic field causes heating and structural damage. Stator shielding along with the use of brushes made of silver graphite at motor shafts to drain out induced currents increases the durability and longevity of structural parts. Permanent magnets suffer hysteresis loss, magnetostriction, and degradation of strength over time as a result.

Commercial EVs employ synchronous motors and the SRMs which require complex monitoring, measurement, timing, and switching mechanisms to implement regenerative braking.

Prior art motors other than the SRM are constrained to operate at designed efficiency in a tight range of RPM primarily due to back Electromotive Force (EMF) which increases with the RPM resulting in opposing torque and added copper and the heating losses. High RPM Synchronous Reluctance Motors require gears to reduce the RPM of wheels adding to weight, friction, and maintenance requirements. Most 3-phase alternating current (AC) systems operate at optimal efficiency at 75% load as the power factor also changes with loading.

Another complication in the EVs is the synchronous speed. No voltage is generated at zero slip when rotor speed equals the stator's synchronous alternating magnetic field RPM. The reducing rotor speed in a braking vehicle must be continuously measured and VFDs are required to continuously reduce the synchronous frequency to induce the voltage.

Michael Faraday created the first prototype of a Homopolar motor in 1821 based on his discovery that a wire carrying DC is deflected in a uniform magnetic field. Subsequent experiments and designs over the last century have failed to output significant torque that is sufficient for practical applications without using very large current supplied by powerful DC generators in conjunction with powerful magnets made from superconducting coils. Apart from size and cost this requires specially engineered electrical and structural materials to handle large current in extreme heat and cryogenic conditions, including liquid metal and spring-loaded electrical brushes for increased contact friction to reduce sparking between the stationary brush supplying DC power and rotating copper disc armature. Design of prior art Homopolar motors is based on an electrically conducting rotor subject to a uniform magnetic field generated from one of: permanent magnets and the one or more coils located in the stator. When DC current is supplied to a rotor disc via electrically conductive brushes a Lorentz force arising from charges in the conductor cumulatively result in a force on the one or more rotors. If the rotor disc is rotated by an external prime mover, it generates DC which is unique to Homopolar generators. This follows from Special Theory of Relativity where an electrical charge (q) within a conductor having velocity (\vec{v}) relative to the inertial frame in magnetic field (B) experiences the Lorentz force (F) directed radially. The Lorentz force is expressed in Equation 1.

$$\vec{F} = q ( \vec{v} \times \vec{B} ) \qquad Equation 1$$

The radial current resulting from the radial electric field cumulatively adds up to a mechanical force that opposes the prime mover. Mechanical work done by the prime mover manifests as DC electrical power output. Consequently, when an external current is supplied through the conductor in the magnetic field the resulting Lorentz force acts upon the conductor by conversion of electric energy to mechanical energy. Sir Michael Faraday discovered that a current is generated even when the disc and magnet are rotated together which seems to contradict his theory of voltage induction since there is no apparent changing magnetic flux.

Homopolar machine designs based on Sir Michael Faraday's disc require very high source current to produce torque due to parallel radial pathways across the disc which is also prone to eddy currents due to relative motion between stator magnets and disc. This causes excessive copper losses, heating and demagnetisation, and reduction in torque.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a statorless electromechanical device and a method thereof, are disclosed.

In accordance with an embodiment of the present disclosure, the statorless electromechanical device is disclosed. The statorless electromechanical device comprises one or more rotors. Each rotor of the one or more rotors is configured with a defined configuration of variable reluctance mechanism for inductive power transfer to receive electric current from a power source. Each rotor comprises at least one of: one or more toroidal rings, one or more petal units, and a controller. The one or more petal units comprise at least one of: one or more magnetic cores, one or more non-magnetic sheets, one or more pairs of magnets, and one or more coils.

In an embodiment, the one or more toroidal rings are operatively positioned along a shared rotational axis of a bud unit. The one or more toroidal rings are configured to provide a mounting structure for torque generation elements. The one or more toroidal rings are configured to be stacked at least one of: concentric arrangement and cylindrical arrangement based on application of a unidirectional torque. The one or more toroidal rings are configured with one of: a rectangular hollow cross-section, a polygonal hollow cross-section, and a curved hollow cross-section and equipped with at least one of: homogeneous petal units of the one or more petal units and heterogeneous petal units of the one or more petal units.

Yet in another embodiment, the one or more petal units are operatively positioned in each toroidal ring of the one or more toroidal rings and the bud unit. The one or more petal units are positioned at one of: angular intervals and angular offset relative to a radial line, along a circumference of each toroidal ring of the one or more toroidal rings and the bud unit. The one or more petal units are configured to operate in a phased activation sequence to trigger adjacent petal units of the one or more petal units sequentially to the avert torque ripple between the adjacent petal units.

Yet in another embodiment, the one or more magnetic cores are operatively positioned inside each toroidal ring and the bud unit. The one or more magnetic cores are configured to provide a flux path for guiding magnetic field to produce the unidirectional torque. Each magnetic core of the one or more magnetic cores is configured as one of: a polygonal solid magnetic core and an annular polygonal magnetic core. The polygonal solid magnetic core is configured to: a) enhance magnetic flux concentration oriented radially along the shared rotational axis and b) direct the magnetic flux to a region of the one or more coils adjacent to the one or more magnetic cores. The magnetic flux is oriented radially inward on the one or more coils and is radially outward on the symmetrically opposite section of the one or more coils, to optimize the unidirectional torque. The annular magnetic core is operatively positioned one of: the outer periphery and the inner periphery of the one or more magnetic cores radially, and tangential to the shared rotational axis. Each magnetic core is configured with at least one of: a hollow inner ferromagnetic toroid, an inner core toroidal segment, alternating toroidal core segments with at least one core segment situated inside the one or more coils.

Yet in another embodiment, the one or more non-magnetic sheets of defined profile are positioned asymmetrically on at least one side of each magnetic core. Yet in another embodiment, the one or more pairs of magnets are operatively positioned on either side of each magnetic core. The one or more pairs of magnets are configured to generate the magnetic field. Each pair of magnets of the one or more pairs of magnets is positioned on symmetrically opposite sides of each magnetic core, with like poles directed towards the one or more magnetic cores to generate magnetic flux oriented radially along the shared rotational axis in opposite directions across symmetrically opposite sections of the one or more coils. The position of each pair of magnets optimizes the magnetic flux interactions with the one or more coils.

Yet in another embodiment, the one or more coils are wound around one of: the outer periphery and the inner periphery of each magnetic core. The one or more coils are operatively connected to the power source. The one or more coils are configured to carry a first force orthogonal to the magnetic field while conducting electric current for generating the unidirectional torque through a second force. The first force is electromagnetic force, and the second force is Lorentz force. The one or more coils are configured to: a) operate in a series configuration to produce an optimal voltage for one or more applications requiring a first range of the unidirectional torque, and b) operate in a parallel configuration to an optimal current for the one or more applications requiring a second range of the unidirectional torque.

Yet in another embodiment, the controller is operatively connected to each petal unit of the one or more petal units. The controller is configured to: a) monitor one or more operational parameters of the statorless electromechanical device, b) orchestrate an operation of each petal unit based on the monitored one or more operational parameters, and c) trigger one of: activation and deactivation of defined petal units of the one or more petal units for controlling the generated unidirectional torque in the statorless electromechanical device. The one or more operational parameters comprise at least one of: a load, rotational speed, temperature, current rating, and target unidirectional torque. The controller is configured with operational instructions to produce one of: a continuously variable torque and a stepwise variable torque based on triggering one of: the activation and the deactivation of at least one of: the homogeneous petal units of the one or more petal units and the heterogeneous petal units of the one or more petal units.

Yet in another embodiment, the statorless electromechanical device comprises one or more additional pair of magnets. The one or more additional pair of magnets are operatively positioned at an offset from the pairs of magnets at a defined distance from a center of the one or more magnetic cores with like poles directed towards the one or more magnetic cores. The statorless electromechanical device is configured to operate in one of: a motor mode and a generator mode.

In accordance with an embodiment of the present disclosure, a method for operating the statorless electromechanical device is disclosed. In the first step, the method includes providing, by the one or more magnetic cores, the flux path for guiding the magnetic field to produce the unidirectional torque.

In the next step, the method includes generating, by the one or more pairs of magnets, the magnetic field in each petal unit. In the next step, the method includes carrying, by the one or more coils, the first force orthogonal to the magnetic field while conducting the electric current from the power source for generating the unidirectional torque through the second force.

In the next step, the method includes monitoring, by the controller, the one or more operational parameters of the statorless electromechanical device. In the next step, the method includes orchestrating, by the controller, the operation of each petal unit based on the monitored one or more operational parameters. In the next step, the method includes triggering, by the controller, one of: the activation and the deactivation of the defined petal units for controlling the generated unidirectional torque in the statorless electromechanical device

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1A illustrates an exemplary block diagram of a statorless electromechanical device, in accordance with an embodiment of the present disclosure;

FIG. 1B illustrates an exemplary isometric view of the statorless electromechanical device, in accordance with an embodiment of the present disclosure;

FIG. 2 illustrates an exemplary isometric view of a bud unit of the statorless electromechanical device, in accordance with an embodiment of the present disclosure;

FIG. 3 to FIG. 20 illustrate various embodiments of one or more petal units of the statorless electromechanical device, in accordance with an embodiment of the present disclosure; and

FIG. 21 illustrates an exemplary flowchart depicting a method for operating the statorless electromechanical device, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

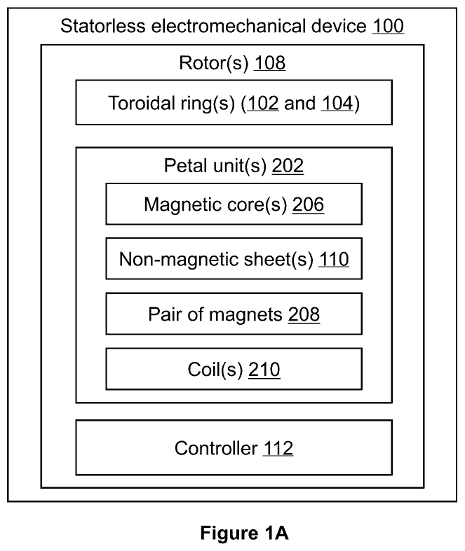

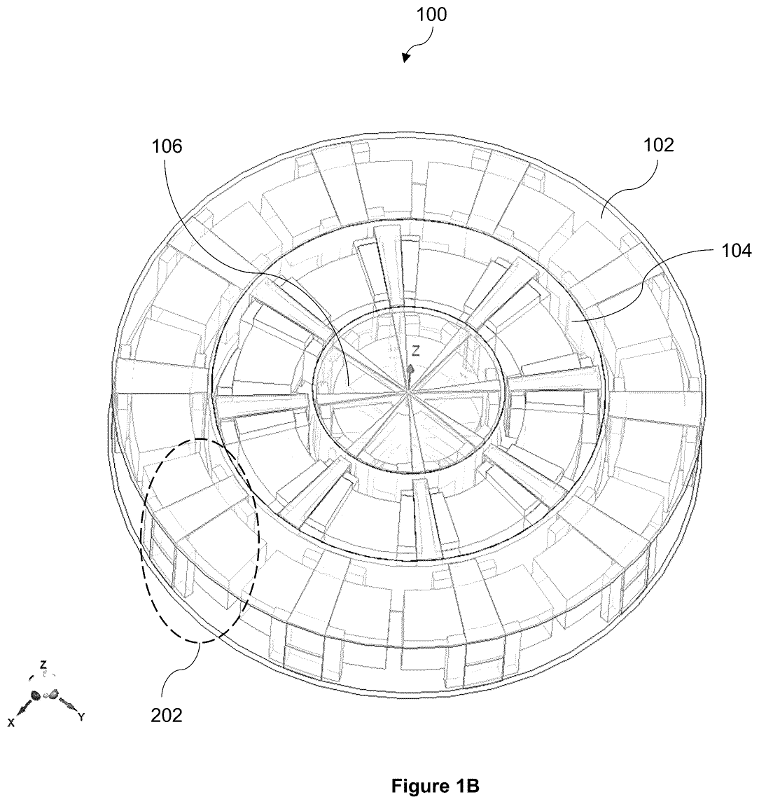

Referring now to the drawings, and more particularly to FIG. 1A through FIG. 21, where similar reference characters denote corresponding features consistently throughout the figures, there are shown preferred embodiments and these embodiments are described in the context of the following exemplary system and/or method.

Embodiments of the present disclosure relate to a statorless electromechanical device to generate torque from one or more coils situated within one or more rotors carrying direct current (DC) at constant voltage, obviating time-varying control voltage supplied to one or more stator coils for relative motion between a stator coil of the one or more stator coils and magnetic or ferromagnetic rotor associated with the one or more rotors or vice versa.

As used herein the term “magnet” refers to one of: a permanent magnet and an electro-magnet that produces magnetic field and is aligned to the edges of the one or more coils and correspondingly takes on either a linear or curved profile based on the cross-section of the one or more coils.

FIG. 1A illustrates an exemplary block diagram of the statorless electromechanical device 100, in accordance with an embodiment of the present disclosure; and

FIG. 1B illustrates an exemplary isometric view of the statorless electromechanical device 100, in accordance with an embodiment of the present disclosure.

According to an exemplary embodiment of the disclosure, the statorless electromechanical device 100 is disclosed. The statorless electromechanical device 100 comprises the one or more rotors 108. Each rotor 108 of the one or more rotors 108 may comprise, but not restricted to, at least one of: one or more toroidal rings (102 and 104), one or more petal units 202, and a controller 112. The one or more petal units 202 may comprise, but not restricted to, at least one of: one or more magnetic cores 206, one or more non-magnetic sheets 110, one or more pairs of magnets 208, and the one or more coils 210.

In an exemplary embodiment, an air cooled rotor (as shown in FIG. 1B) associated with the one or more rotors 108 formed of an outermost toroidal ring 102 associated with the one or more toroidal rings (102 and 104), an innermost toroidal ring 104 associated with the one or more toroidal rings (102 and 104), and a bud unit 106 that are hollow and configured with rectangular cross section containing multiple instances of a single type of petal unit associated with the one or more petal units 202.

In an exemplary embodiment, the one or more rotors 108 are configured with air vents along an outer surface of its housing. A central shaft is configured with at least one of: helical grooves and helical fins to induce slow axial airflow and cross-ventilation via the air vents resulting in heat transfer as well as removal of hot air and thereby air cooling of its constituents. An alternative embodiment of the statorless electromechanical device 100 may exclude an outer housing and only include helical grooves on the central shaft. Other embodiments of the statorless electromechanical device 100 that are not operating in constrained spaces with one of: low ventilation and configured with moderate operating torque density may use a smooth metal central shaft with one of: no helical groove and special surface devices to accelerate air flow.

Certain embodiments of the statorless electromechanical device 100 with high torque density requirements and high operating current may require external cooling by pumping and circulation of a refrigerant in specially designed tubing around the one or more rotors 108.

In another alternative embodiment of the statorless electromechanical device 100, counter-rotating rotors associated with the one or more rotors 108 comprise two coaxial concentric shafts with bearings between outer shafts and inner shafts with one shaft attached via one of: spokes and arms to a first rotor associated with the one or more rotors 108 rotating clockwise and the other attached to a second rotor associated with the one or more rotors 108 rotating counterclockwise that is disposed one of: above and below the first rotor with an air gap between them to enable independent rotation. Loads such as propellers may be attached to each counter-rotating shaft. In one arrangement the external shaft is hollow and contains a sleeve bearing that enables rotation of the internal shaft inside it. In another arrangement, the two shafts extend outward axially in opposite directions on either side of a motor. In another alternative arrangement, the first rotor is attached to the central shaft whereas the counter-rotating second rotor is rim-mounted using the bearings attached to an outer casing of the motor.

In an exemplary embodiment, the one or more toroidal rings (102 and 104) are operatively positioned along a shared rotational axis of the bud unit 106. The one or more toroidal rings (102 and 104) are configured to provide a mounting structure for torque generation elements. The one or more toroidal rings (102 and 104) are configured to be stacked at least one of: concentric arrangement and cylindrical arrangement based on application of a unidirectional torque. The one or more toroidal rings (102 and 104) are configured with one of: a rectangular hollow cross-section, a polygonal hollow cross-section, and a curved hollow cross-section and equipped with at least one of: homogeneous petal units of the one or more petal units 202 and heterogeneous petal units of the one or more petal units 202.

Other alternative embodiments of the statorless electromechanical device 100 may comprise one or more concentric toroidal rings (102 and 104) of different radii and a cylindrical stack of toroidal rings (102 and 104) of the same radii that may optionally include a cooling infrastructure.

In an exemplary embodiment, the one or more petal units 202 are operatively positioned in each toroidal ring (102 and 104) of the one or more toroidal rings (102 and 104) and the bud unit 106. The one or more petal units 202 are positioned at one of: angular intervals and angular offset relative to a radial line, along a circumference of each toroidal ring (102 and 104) of the one or more toroidal rings (102 and 104) and the bud unit 106. The one or more petal units 202 are configured to operate in a phased activation sequence to trigger adjacent petal units of the one or more petal units 202 sequentially to the avert torque ripple between the adjacent petal units.

In an exemplary embodiment, the controller 112 is operatively connected to each petal unit 202 of the one or more petal units 202. The controller 112 is configured to monitor one or more operational parameters of the statorless electromechanical device 100. The controller 112 is configured to orchestrate an operation of each petal unit 202 based on the monitored one or more operational parameters. The controller 112 orchestrate the one or more petal units 202 in a synchronized manner to achieve the desired one or more operational parameters (target unidirectional torque, angular acceleration, or Revolutions per minute (RPM)) utilising proprietary training data and neural network or machine learning models to determine optimal addresses of the one or more petal units 202 and the bud unit 106 to achieve a target unidirectional torque and the RPM including subgroups to implement fine-grained adjustments.

The controller 112 is configured to trigger one of: activation and deactivation of defined petal units 202 of the one or more petal units 202 for controlling the generated unidirectional torque in the statorless electromechanical device 100. The one or more operational parameters comprise at least one of: a load, rotational speed, temperature, current rating, and target unidirectional torque. The controller 112 is configured with operational instructions to produce one of: a continuously variable torque and a stepwise variable torque based on triggering one of: the activation and the deactivation of at least one of: the homogeneous petal units of the one or more petal units 202 and the heterogeneous petal units of the one or more petal units 202.

The controller 112 is configured to transmit the operational instructions to at least one of: the one or more petal units 202 and the bud unit 106 to one of: electronically connect and disconnect from a power source (Direct Current (DC) power source) 204. The controller 112 is configured to synchronise orchestration of one or more statorless electromechanical device 100 by using multicast messaging with named group addresses that include one or more groups of corresponding one or more petal units 202 from the one or more statorless electromechanical device 100. The controller's 112 user interface is employed to select specific petal units 202 of the one or more petal units 202 from the one or more statorless electromechanical device 100, provisioning them as nodes in the network and allocate group addresses during network configuration.

Variable torque control approaches may include switching on all the one or more petal units 202 in the one or more rotors 108 to start the statorless electromechanical device 100 with the highest torque and gradually switching off groups from the outermost toroidal ring 102 to the innermost toroidal ring 104, ending with the bud unit 106. Alternatively, the one or more petal units 202 are configured with a subset of petal units 202 within the one or more petal units 202 that are positioned at specific angular intervals within the outermost toroidal ring 102 to the innermost toroidal ring 104. This enables more fine-grained torque control by stepwise switching each petal unit 202 of the one or more petal units 202 within the outermost toroidal ring 102 to the innermost toroidal ring 104 and the bud unit 106. Various control models may comprise, but not restricted to, at least one of: one or more proportional integral derivative (PID) models, one or more machine learning models, one or more deep reinforcement learning models, and other artificial intelligence-based techniques are employed to optimize the target unidirectional torque, the RPM, and power consumption based on the one or more operating parameters.

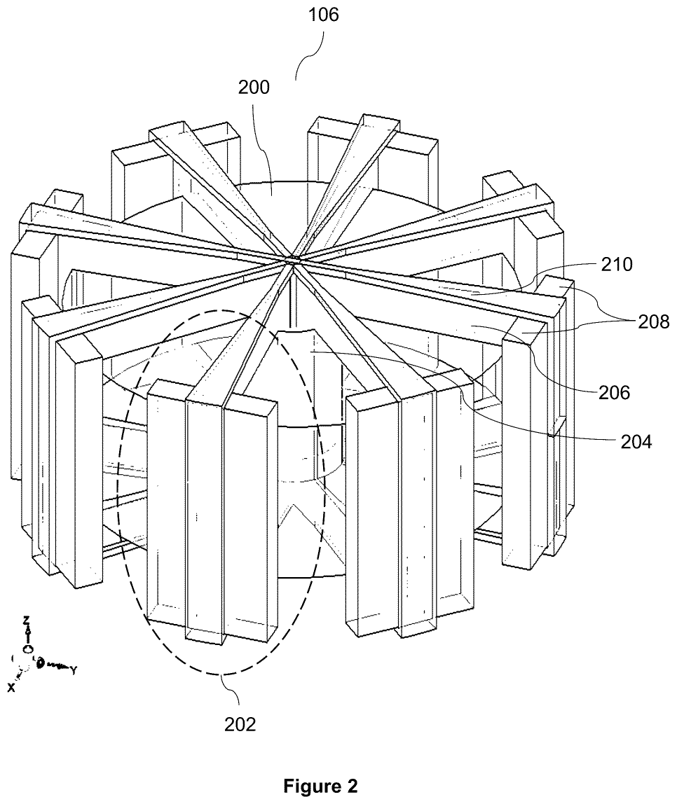

FIG. 2 illustrates an exemplary isometric view of the bud unit 106 of the statorless electromechanical device 100, in accordance with an embodiment of the present disclosure.

In an exemplary embodiment, the bud unit 106 comprises an assembly of the one or more petal units 202 around the shared rotational axis at the regular angular intervals along with an inner ferromagnetic segment 200. In the illustrative embodiment, the power source 204 is positioned at, but not limited to, a centre of the bud unit 106.

In an exemplary embodiment, the one or more magnetic cores 206 are operatively positioned inside each toroidal ring (102 and 104) and the bud unit 106. The one or more magnetic cores 206 are configured to provide a flux path for guiding magnetic field to produce the unidirectional torque.

Each magnetic core 206 of the one or more magnetic cores 206 is configured as one of: a polygonal solid magnetic core and an annular polygonal magnetic core. The polygonal solid magnetic core is configured to enhance magnetic flux concentration oriented radially along the shared rotational axis. The polygonal solid magnetic core is configured to direct the magnetic flux to a region of the one or more coils 210 adjacent to the one or more magnetic cores 206. The magnetic flux is oriented radially inward on the one or more coils 210 and is radially outward on the symmetrically opposite section of the one or more coils 210, to optimize the unidirectional torque.

The annular magnetic core is operatively positioned one of: the outer periphery and the inner periphery of the one or more magnetic cores 206 radially, and tangential to the shared rotational axis. Each magnetic core 206 is configured with at least one of: a hollow inner ferromagnetic toroid (discussed in paragraph [0075]), an inner core toroidal segment (discussed in paragraph [0077]), alternating toroidal core segments with at least one core segment situated (discussed in paragraph [0082]) inside the one or more coils 210.

The one or more magnetic cores 206 in the exemplary embodiment shown in FIG. 2 is configured with a rectangular cross-section as well as a profile. Other embodiments may have at least one of: rectangular, polygonal cross-section, and the profile. The bud unit 106 may optionally be enclosed within a toroidal outer hollow ferromagnetic shell (not shown) for magnetic shielding, thereby improving heat transfer and reducing windage and noise.

In an exemplary embodiment, the one or more pairs of magnets 208 are operatively positioned on either side of each magnetic core 206 around which the one or more coils 210 are wound. The one or more pairs of magnets 208 are configured to generate the magnetic field. Each pair of magnets 208 of the one or more pairs of magnets 208 is positioned on symmetrically opposite sides of each magnetic core 206, with like poles directed towards the one or more magnetic cores 206 to generate magnetic flux oriented radially along the shared rotational axis in opposite directions across symmetrically opposite sections of the one or more coils 210. The position of each pair of magnets 208 optimizes the magnetic flux interactions with the one or more coils 210.

Each magnet 208 is optionally disposed at one of: a specified distance relative to the surface of the one or more magnetic cores 206 and alternatively the one or more non-magnetic sheets 110 are disposed between each magnet 208 and the one or more magnetic cores 206. The one or more non-magnetic sheets 110 of defined profile are positioned asymmetrically on at least one side of each magnetic core 206.

The one or more non-magnetic sheets 110 are at least one of: configured with low relative permeability and non-magnetic. The one or more non-magnetic sheets 110 may be constructed from, but not limited to, at least one of: plastics, woods, glass, polymers, and the like. The shape of the one or more pairs of magnets 208 is influenced by the profile shape of the one or more magnetic cores 206. While the embodiment shown in FIG. 2 depicts rectangular shaped petal unit of the one or more petal units 202, other polygonal geometries are possibly guided by overall petal unit profile geometry which may be at least one of: polygonal, circular, and other operating constraints such as output torque, efficiency, magnetic field saturation, flux pathways, and the like. One such alternative embodiment may have a torus shaped magnetic core 206 associated with the one or more magnetic cores 206 with arc segment magnets 208 instead of rectangular bar magnets shown in FIG. 2.

It must be noted that details of electrical connections such as location and powering of switches, antennas and other switching infrastructure are omitted for clarity in the following section despite their usage. The one or more coils 210 are wound around one of: the outer periphery and the inner periphery of each magnetic core 206. The one or more coils 210 are operatively connected to the power source 204.

The one or more coils 210 are configured to carry a first force orthogonal to the magnetic field while conducting electric current for generating the unidirectional torque through a second force. The first force is electromagnetic force, and the second force is Lorentz force. The one or more coils 210 are configured to operate in a series configuration to produce an optimal voltage for one or more applications requiring a first range of the unidirectional torque. The one or more coils 210 are configured to operate in a parallel configuration to an optimal current for the one or more applications requiring a second range of the unidirectional torque.

The one or more coils 210 within each petal unit 202 of the one or more petal units 202 in the bud unit 106 are electrically connected to the power source 204 by connecting open ends of the one or more coils 210 resulting in the parallel configuration of the one or more coils 210 to the power source 204 located inside the housing of the bud unit 106. The electrical current is divided equally amongst all petal units 202 of the one or more petal units 202, whereas the number of turns in each coil 210 multiplies the Lorentz force.

In an exemplary embodiment, the statorless electromechanical device 100 is configured to operate in one of: a motor mode and a generator mode. The motor mode operates upon receiving the electric current from the power source 204 to the one or more coils 210, thereby producing the first force orthogonal to the magnetic field generated by the one or more pairs of magnets 208 to generate the unidirectional torque. The generator mode operates by a rotational motion of the one or more rotors 108 driven by an external mechanical force and induces a voltage in the one or more coils 210 for powering at least one of: an external load and the power source 204.

Alternative embodiments of the bud unit 106 may house one or more instances of the power source 204 one of: inside and outside the one or more toroidal rings 104. Electrical connections may require change from parallel to alternative topology for equal current distribution in each petal unit 202 of the one or more petal units 202 to produce a uniform distribution of torque across the angular intervals in the bud unit 106. This principle extends to the one or more petal units 202 that are situated outside the bud unit 106 such as in the one or more toroidal rings 104.

One or more axially symmetric petal units of the one or more petal units 202 may be grouped into at least one of: electrically series-connected units and electrically isolated units located at the specific angular intervals across the one or more toroidal rings (102 and 104) that together comprise a rotor 108 of the one or more rotors 108. Connected one or more petal units 202 may or may not be adjacent but are connected to a single power source 204. Different motor embodiments may potentially employ different techniques and mechanisms to manufacture and assemble the one or more petal units 202 along the one or more toroidal rings (102 and 104) that are optimised for the embodiment.

A petal group may comprise at least one of: the one or more petal units 202 and one or more petal groups. The one or more petal groups support one or more wireless protocols including point-to-point as well as mesh networking beacon, multicast, and publish-subscribe protocols using standards such as Bluetooth® Low Energy (BLE), Zigbee®, Thread, or other protocols known in the art that support unique addressing. A wireless transceiver receives signals from and transmits health status to the controller 112 and may use any electronic switch known in the art such as insulated-gate bipolar transistors (IGBT), Metal Oxide Silicon Field Effect Transistors (MOSFET), Silicon Controlled Rectifier (SCR), and the like to one of: connect and disconnect the one or more coils 210 to the power source 204. On disconnection, the wireless transceiver may optionally go to sleep for a configured time interval to conserve electric power.

The wireless transceiver may optionally include semiconductor components and circuitry that allow unidirectional current such as a diode, Metal Oxide Silicon Field Effect Transistors (MOSFET), and equivalent. At least one of: a double pole double throw (DPDT) relay and a circuit with one or more solid-state switches in a configuration such as Half bridge, H-bridge, and alternative may be used to reverse voltage polarity applied to the one or more coils 210 for the statorless electromechanical device 100 to produce torque in the reverse direction.

In some embodiments, the one or more toroidal rings (102 and 104) are referred to as one or more toroidal cores. One approach for specification of the one or more petal groups is based on homogeneity of petal unit configurations where the one or more petal units 202 assembled in the one or more toroidal cores are of the same configuration. In an alternative embodiment with heterogenous petal unit types per toroidal core of the one or more toroidal cores, a grouping approach may be based on logical grouping by homogenous petal configuration and an optional aggregate group that may include all petal configurations in the one or more toroidal cores. Another approach for the petal grouping is one of: torque characteristics and RPM variation where low petal group cardinality enables a continuous variation in the torque whereas high petal group cardinality results in bigger increments of the torque.

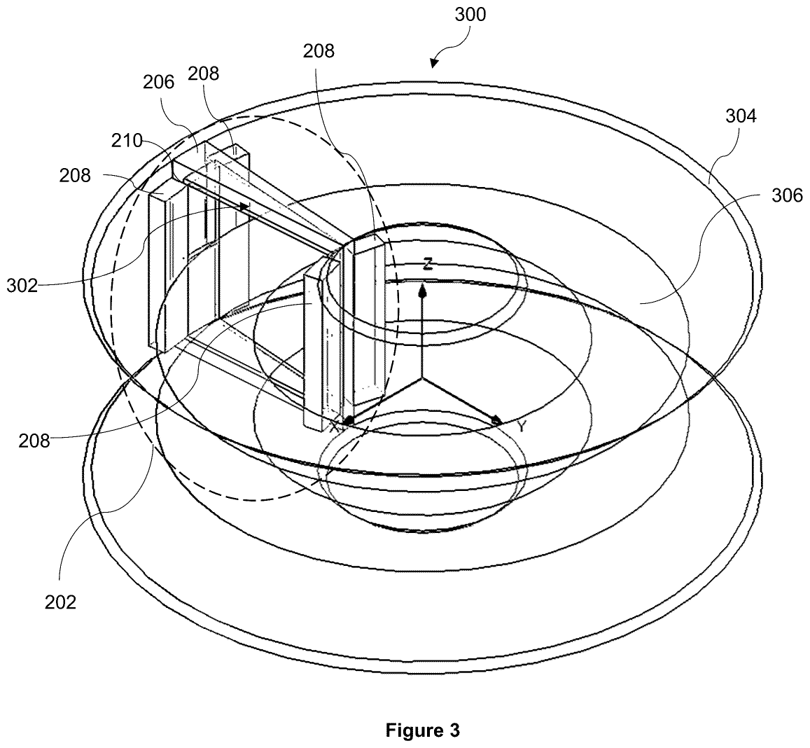

FIG. 3 to FIG. 21 illustrate various embodiments of the one or more petal units 202 of the statorless electromechanical device 100, in accordance with an embodiment of the present disclosure.

In an exemplary embodiment, the statorless electromechanical device 100 comprises one or more additional pair of magnets. The one or more additional pair of magnets are operatively positioned at an offset from the pair of magnets 208 at a defined distance from a center of the one or more magnetic cores 206 with like poles directed towards the one or more magnetic cores 206. In an exemplary embodiment, FIG. 3 depicts a detailed view of an exemplary embodiment of the one or more petal units 202 of a first configuration 300 comprising the one or more pairs of magnets 208 along with the one or more additional pair of magnets (together referred to as two or more pairs of magnets) positioned on either side of the magnetic core 206 of annular rectangular cross-section with the like poles oriented normally to a surface 302 of the one or more magnetic cores 206.

A rectangular coil 210 of the one or more coils 210 is connected to the power source 204. The rectangular coil 210 is positioned at an inner diameter of the one or more magnetic cores 206 around an optionally hollow inner ferromagnetic toroid 306 associated with the one or more magnetic cores 206 housing the power source 204. The assembly is optionally enclosed in an outer ferromagnetic shield 304. An alternative embodiment comprises the two or more pairs of magnets 208 located on either side of a bar-shaped magnetic core 206 associated with the one or more magnetic cores 206. In an alternative embodiment, the hollow inner ferromagnetic toroid 306 may be solid. In other alternative embodiments, the one or more petal units 202 along with the one or more coils 210, the one or more magnetic cores 206, 306, and/or 304 may have one of: polygonal and curved sections.

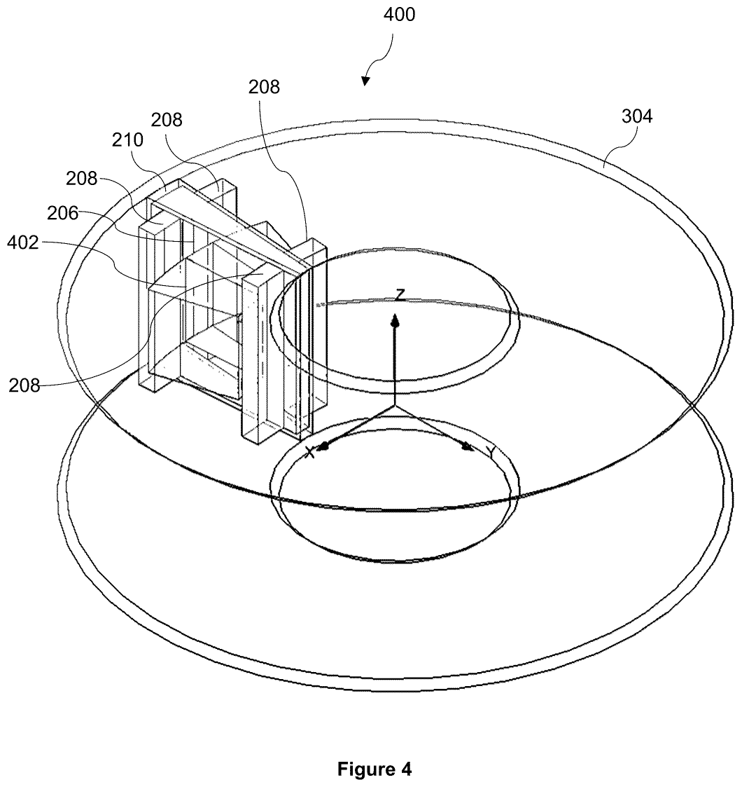

In an exemplary embodiment, FIG. 4 depicts an isometric view of an exemplary embodiment of the one or more petal units 202 of a second configuration 400 that are circumferentially assembled inside the outer ferromagnetic shield 304 with an air gap between adjacent toroidal inner ferromagnetic core 402 associated with the one or more magnetic cores 206. The two or more pairs of magnets 208 are located on either side of the one or more magnetic cores 206 of annular polygonal cross-section, which interfaces on all sides with the one or more coils 210 of polygonal cross-section, wherein a height of the one or more coils 210 may be one of: equal to and greater than that of the one or more magnetic cores 206.

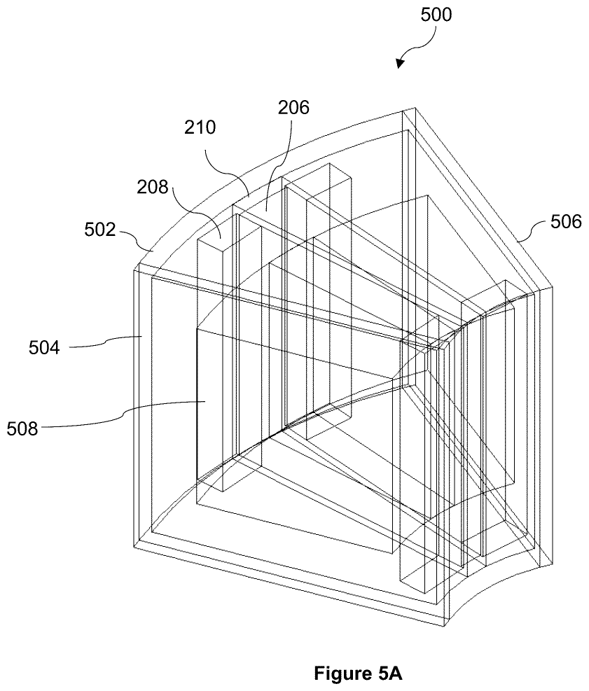

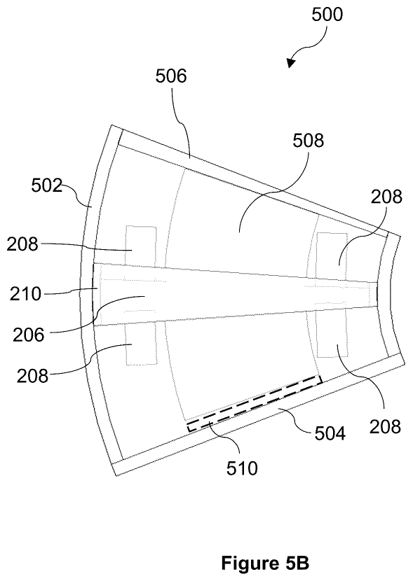

In an exemplary embodiment, FIGS. 5A-5B depict an isometric view of an exemplary embodiment of the one or more petal units 202 of a third configuration 500. Each petal unit 202 comprises an enclosing hollow ferromagnetic outer toroidal segment 502, an inner core toroidal segment 508 with an optional air gap at either end that is optionally bounded by a first ferromagnetic cover 504 and a second ferromagnetic cover 506 that interface with the hollow ferromagnetic outer toroidal segment 502. In an exemplary embodiment, FIG. 5B depicts the isometric view of the third configuration 500 associated with the one or more petal units 202 with an axial air gap 510 between the first ferromagnetic cover 504 and the inner core toroidal segment 508. In another alternative embodiment, one of: the first ferromagnetic cover 504 and the second ferromagnetic cover 506 is not present.

An alternative embodiment excludes the first ferromagnetic cover 504 and the second ferromagnetic cover 506 at either end of the inner core toroidal segment 508. A magnetic flux circuit may be formed by bringing adjacent one or more petal units 202 of the one or more petal units 202 in contact, wherein separate low reluctance magnetic flux pathways are formed across the inner core toroidal segment 508 and the hollow ferromagnetic outer toroidal segment 502 of adjoining one or more petal units 202 of the one or more petal units 202. Another alternative embodiment excludes the inner core toroidal segment 508.

An alternative embodiment of the one or more petal units 202 in the third configuration 500 may incorporate magnetically shielding sleeves 516 enclosing each magnet 208 to reduce interference from the magnetic field of the one or more coils 210.

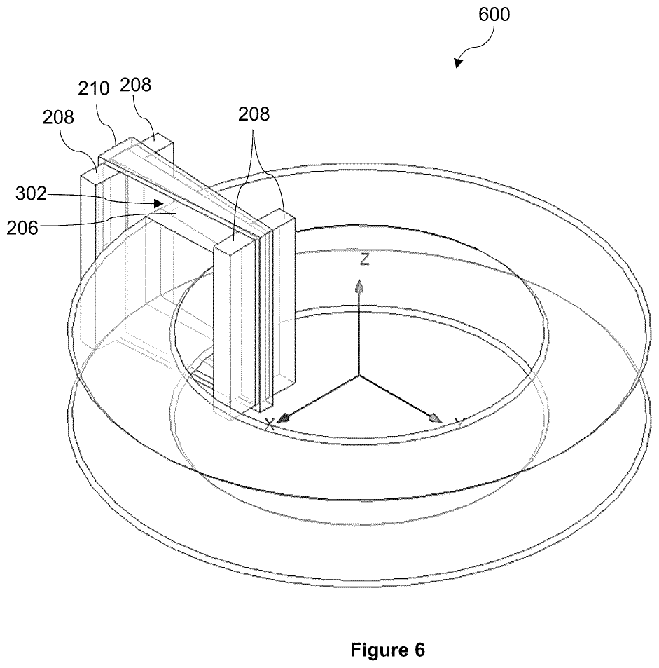

In an exemplary embodiment, FIG. 6 depicts an isometric view of an exemplary embodiment of a fourth configuration 600 of the one or more petal units 202 that are assembled along an optionally hollow inner ferromagnetic toroid 306. Each petal unit 202 of the one or more petal units 202 comprises the two or more pairs of magnets 208 positioned along two or more opposite edges respectively of a polygonal shaped magnetic core 206 of the annular cross-section that is bounded at all sides by DC-powered one or more coils 210 of the polygonal cross-section with the like poles oriented normal to the surface 302 of the one or more magnetic cores 206.

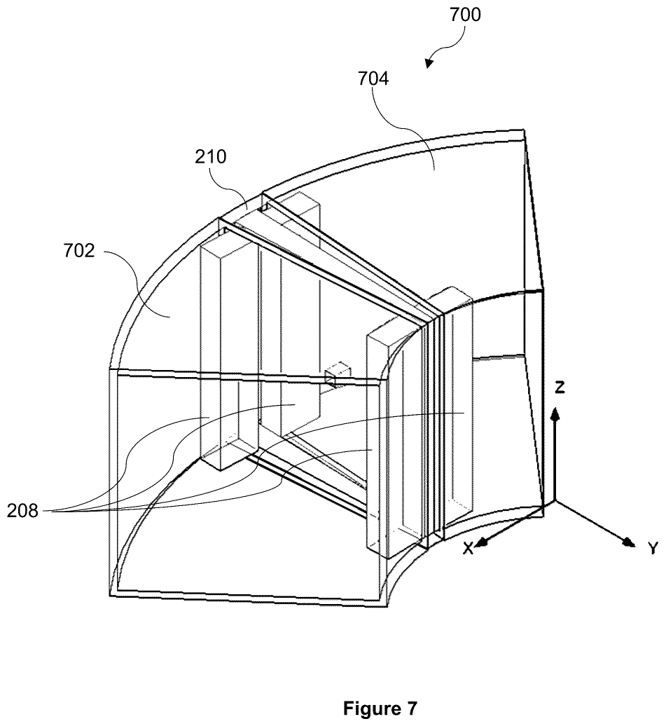

In an exemplary embodiment, FIG. 7 depicts an isometric view of an exemplary embodiment of the one or more petal units 202 of a fifth configuration 700 comprising a first inner hollow ferromagnetic toroidal core segment 702, a second inner hollow ferromagnetic toroidal core segment 704, the one or more coils 210 sandwiched between the adjacent ferromagnetic toroidal core segments (702 and 704). Magnetic flux traverses across the first inner hollow ferromagnetic toroidal core segment 702 and the second inner hollow ferromagnetic toroidal core segment 704 via the gap across the one or more coils 210 and across adjoining one or more petal units 202 of the one or more petal units 202 in this manner in a toroidal flux path.

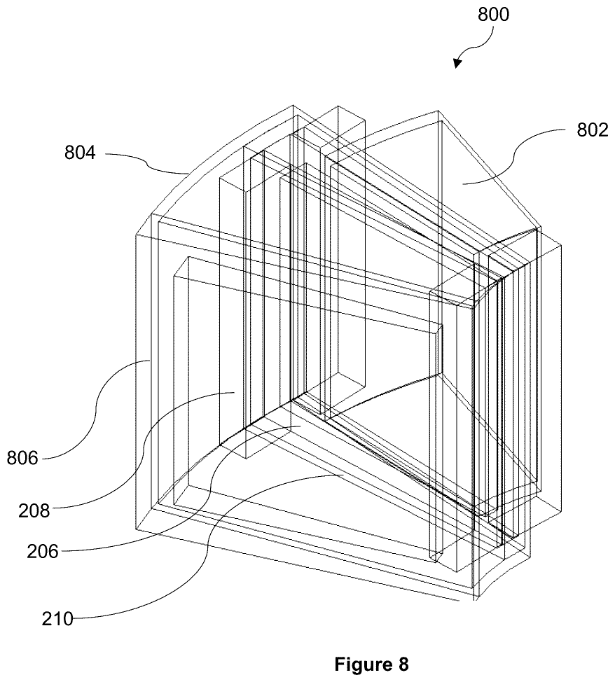

In an exemplary embodiment, FIG. 8 depicts an isometric view of an exemplary embodiment of the one or more petal units 202 of a sixth configuration 800 comprising the DC-powered one or more coils 210 wound around the one or more magnetic cores 206 of the annular cross-section in-between a smaller hollow toroidal core segment 802 and a larger hollow toroidal core segment 804. The smaller hollow toroidal core segment 802 and a larger hollow toroidal core segment 804 are associated with the alternating toroidal core segments (802 and 804). The two or more pairs of magnets 208 are located on either side of the one or more magnetic cores 206 of the annular cross-section. A second annular magnetic core 806 of the one or more magnetic cores 206 of polygonal cross-section interfaces with the larger hollow toroidal core segment 804 enabling a low reluctance magnetic flux pathway across the adjoining one or more petal units 202 of the one or more petal units 202 when arranged in the toroidal assembly. In an alternative embodiment, the positions of the two concentric toroidal segments that are the smaller hollow toroidal core segment 802 and the larger hollow toroidal core segment 804 are mirrored relative to the one or more coils 210 to facilitate optimal torque generation for current flowing in the reverse direction.

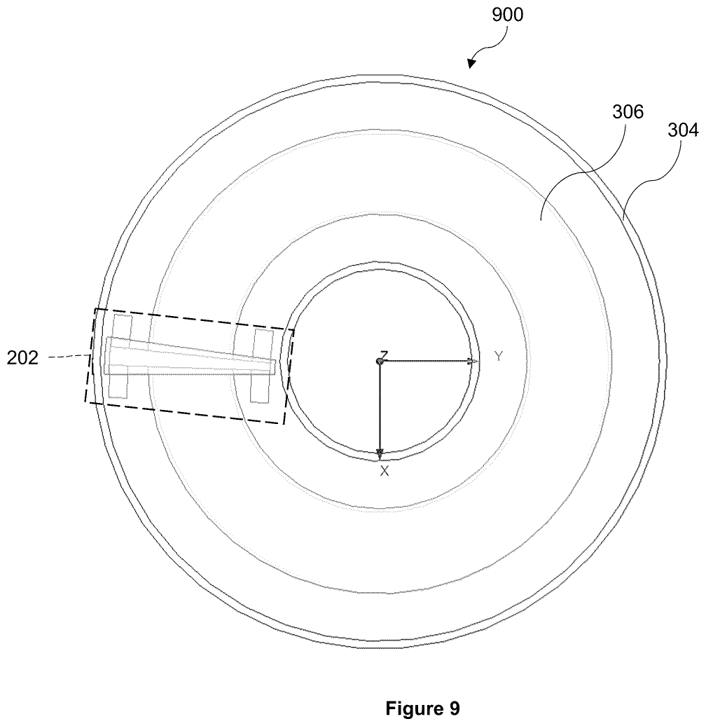

In an exemplary embodiment, FIG. 9 depicts a top view of an exemplary embodiment of the one or more petal units 202 of a seventh configuration 900 wherein each petal unit 202 of the one or more petal units 202 is oriented at the angular offset relative to the radial line from its position on the hollow inner ferromagnetic toroid 306. The offset angle is directly proportional to a DC rating of the one or more coils 210 and a DC voltage of the power source 204. The one or more petal units 202 and embodiments in scope of this disclosure may be assembled into slots that are oriented with the specified offset angle at the regular angular intervals along the hollow inner ferromagnetic toroid 306. The assembly may optionally be enclosed within the outer ferromagnetic shield 304 for magnetic shielding.

An alternative embodiment of the seventh configuration may contain a specific combination of petal units 202 of the one or more petal units 202 of which some are oriented at an angular offset relative to the radial line from its position on the hollow inner ferromagnetic toroid 306 and angular offset for the remainder petal units 202 of the one or more petal units 202 is zero. The assembly may optionally be enclosed within the outer ferromagnetic shield 304.

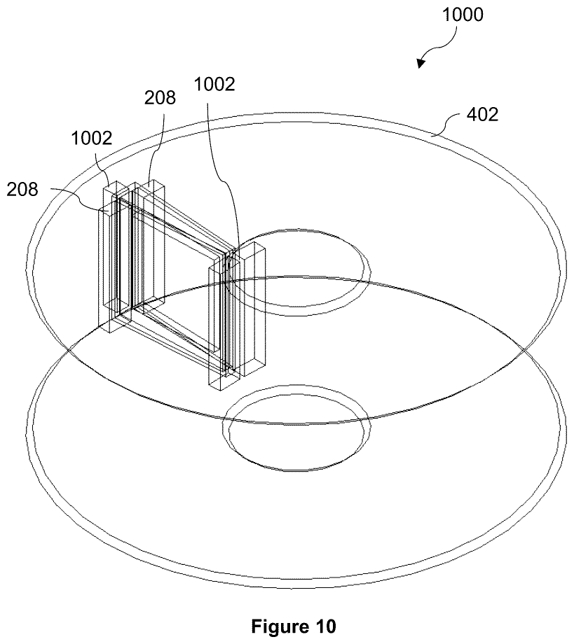

In an exemplary embodiment, FIG. 10 depicts an isometric view of an exemplary embodiment of the one or more petal units 202 of an eighth configuration 1000 comprising the two or more pairs of magnets 208 located outside the one or more coils 210 of the polygonal cross-section with the like poles facing ferromagnetic bars 1002 at opposite ends of the one or more coils 210 along its outer faces. In one embodiment of the either configuration, the toroidal inner ferromagnetic core 402 is one of: a hollow toroid and a solid toroid. In an alternative embodiment, the toroidal inner ferromagnetic core 402 is a toroidal segment with the air gaps separating the adjacent one or more petal units 202 of the one or more petal units 202 assembled within the outer hollow toroidal ferromagnetic shield 304. In an alternative embodiment, an outer ferromagnetic ring of the one or more toroidal rings (102 and 104) that surrounds the one or more coils 210 is employed instead of ferromagnetic bars 1002.

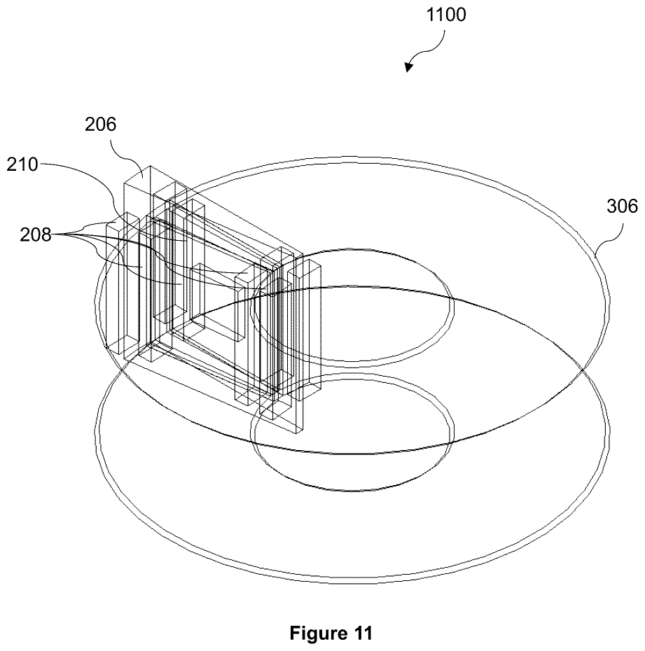

In an exemplary embodiment, FIG. 11 depicts an isometric view of an exemplary embodiment of the one or more petal units 202 of a ninth configuration 1100 which includes all components of the fourth configuration (FIG. 6) and the eighth configuration (FIG. 10) resulting in the ferromagnetic annular magnetic cores 206 and corresponding one or more pairs of magnets 208 located both inside and outside the one or more coils 210. The like poles of the one or more pairs of magnets 208 located inside the one or more coils 210 are inverted relative to the poles of the corresponding one or more pairs of magnets 208 positioned outside the one or more coils 210. In an alternative embodiment, the hollow inner ferromagnetic toroid 306 is absent and the annular cross-section of magnetic core 206 that bounds the one or more coils 210 is radially thinner than the one or more magnetic cores 206 that are inside the one or more coils 210. Another alternative embodiment employs the one or more magnetic cores 206 of the bar-shaped cross-section instead of the one or more magnetic cores 206 of the annular cross-section.

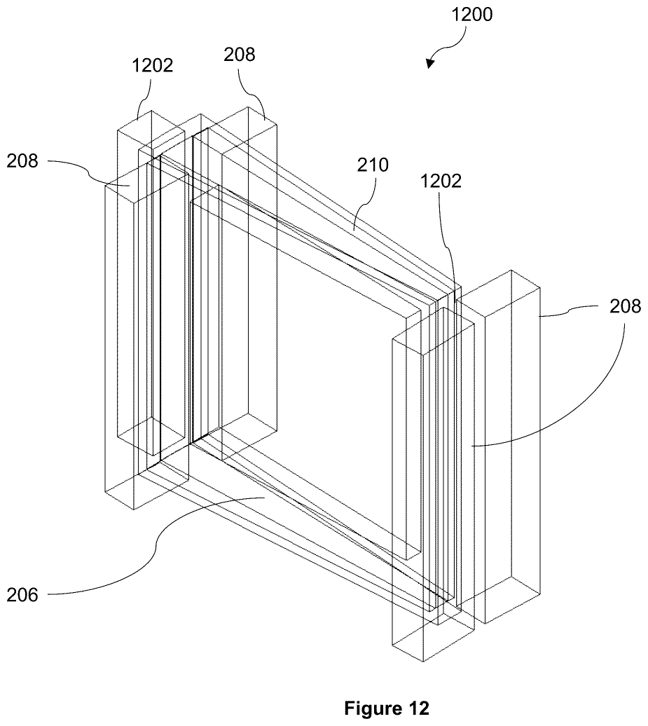

In an exemplary embodiment, FIG. 12 depicts an isometric view of an exemplary embodiment of the one or more petal units 202 of a tenth configuration 1200 comprising the one or more magnetic cores 206 of the annular cross-section that is bounded by the one or more coils 210. A pair of ferromagnetic cores 1202 associated with the one or more magnetic cores 206 of the polygonal shape are located outside opposite sides of the one or more coils 210. The one or more pairs of magnets 208 of the polygonal shape are located inside the one or more coils 210 optionally at a distance with the like poles oriented towards the surface of the one or more magnetic cores 206. The one or more additional pair of magnets are located at the opposite end of the one or more coils 210 on either side of a polygonal core piece associated with the pair of ferromagnetic cores 1202 situated outside the one or more coils 210. Various alternative embodiments may include combinations of pole orientations of the one or more pairs of the magnets 208 located inside the one or more coils 210 that may be one of: the same and inversion of the like poles of the one or more pairs of the magnets 208 located outside the one or more coils 210. In an alternative embodiment, the annular magnetic core 206 bounded by the one or more coils 210 is replaced by a bar-shaped magnetic core associated with the one or more magnetic cores 206.

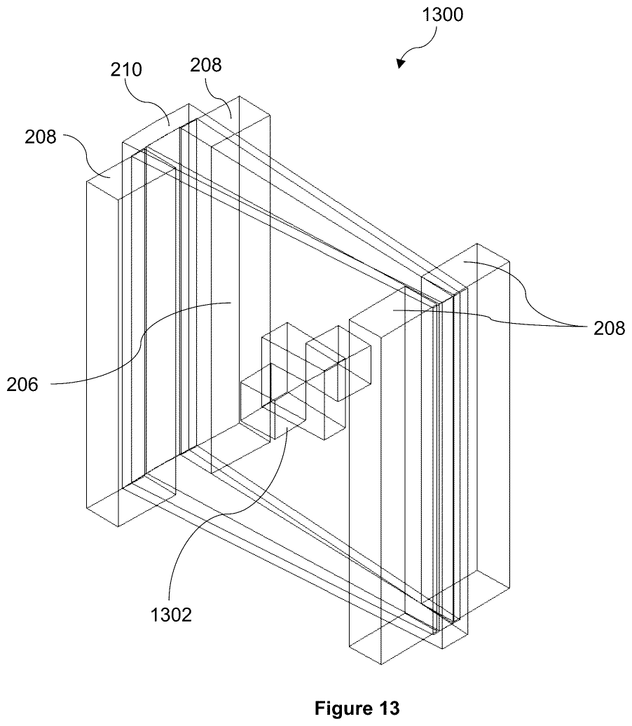

In an exemplary embodiment, FIG. 13 depicts an exemplary embodiment of an isometric view of the one or more petal units 202 of an eleventh configuration 1300. The eleventh configuration 1300 extends the fourth configuration (FIG. 6) but excludes the hollow inner ferromagnetic toroid 306 and includes a first pair of magnets 1302 associated with the one or more pairs of magnets 208 aligned axially along the centre with the like poles facing each other on opposite sides of the one or more magnetic cores 206 of the annular cross-section but inside the hollow region bounded by the inner edge of the annular core. Each magnet 1302 of the first pair of magnets 1302 may be positioned at an axial distance from the centre of the one or more magnetic cores 206 along the circular path of the ferromagnetic toroid and optionally at a radial distance from the inner dimension of the one or more magnetic cores 206.

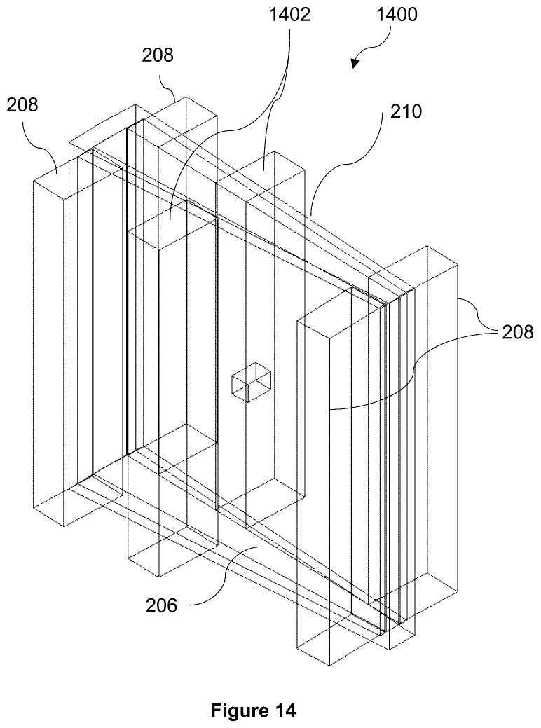

In an exemplary embodiment, FIG. 14 depicts an isometric view of an exemplary embodiment of the one or more petal units 202 of a twelfth configuration 1400 that extends the fourth configuration (FIG. 6) with the one or more additional pair of magnets 1402 positioned at an offset from the one or more pairs of magnets 208 that is farther from the centre of the toroidal inner core and having the same pole orientation. The one or more additional pairs of magnets 1402 may be positioned immediately adjacent to the one or more pairs of magnets 208 that are one of: farther most from the centre of the one or more petal units 202 and at any position between the same pair of magnets 208 and the inner edge of the annular one or more magnetic cores 206.

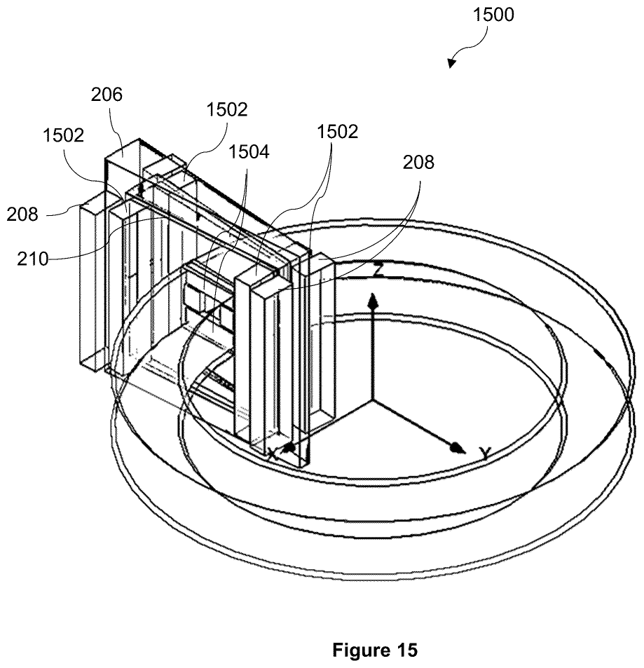

In an exemplary embodiment, FIG. 15 depicts an isometric view of an exemplary embodiment of the one or more petal units 202 of a thirteenth configuration 1500 that extends the fourth configuration (FIG. 6) with the one or more pairs of magnets 208 oriented towards the ferromagnetic annular magnetic core 206 bounding the one or more coils 210 and one or two additional magnet pairs 1504 whose like poles face each other and are co-planar with and located within the hollow region of the hollow inner ferromagnetic toroid 306, at certain radial distance and optional axial distance from corresponding pair of opposite polygonal inner edges of an inner annular core 1506 associated with the one or more magnetic cores 206. Alternative embodiments may exclude one pair of co-planar inner magnets associated with the one or two additional magnet pairs 1504 along one of: vertical inner edges and horizontal inner edges of the inner annular core 1506. Alternative embodiments may either exclude the one or more second pair of magnets 1502 from the fourth configuration. An alternative embodiment excludes the hollow inner ferromagnetic toroid 306.

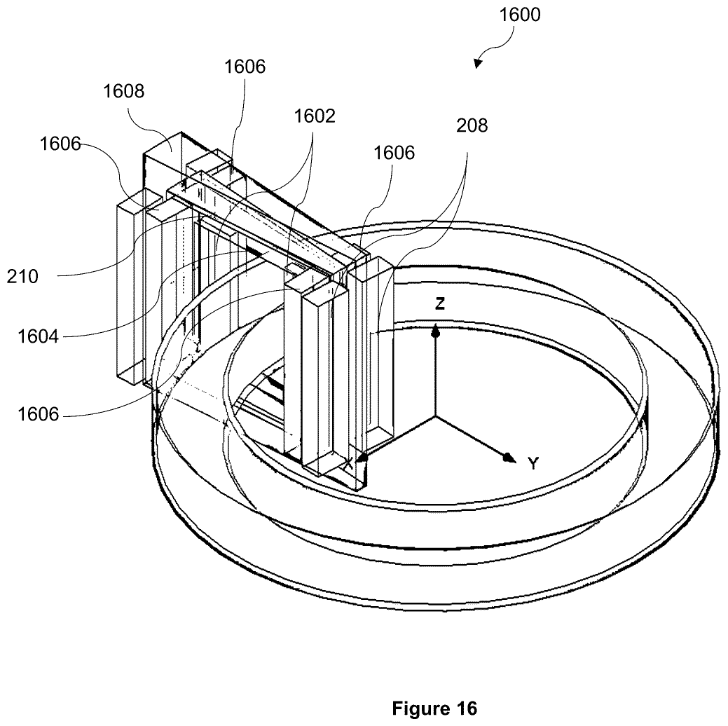

In an exemplary embodiment, FIG. 16 depicts an isometric view of an exemplary embodiment of the one or more petal units 202 of a fifteenth configuration 1600 that extends the ninth configuration (FIG. 11) with one or more second pairs of magnets 1602 of the one or more pairs of magnets 208 whose like poles face each other. The one or more second pairs of magnets 1602 are co-planar with and positioned within the hollow region at optional axial and radial distances from the polygonal inner edge of the inner annular core 1604. In an alternative embodiment, one or more additional first pairs of magnets 1606 of the one or more additional pair of magnets are located along the outer edge and co-planar with the outer annular core 1608. Various embodiments result from permutations of like pole orientations of each pair of magnets 208. In a preferred embodiment, the one or more pairs of magnets 208 with the poles oriented against the inner annular core 1604 are configured with inverted poles of corresponding one or more pairs of magnets oriented against the outer annular core 1608.

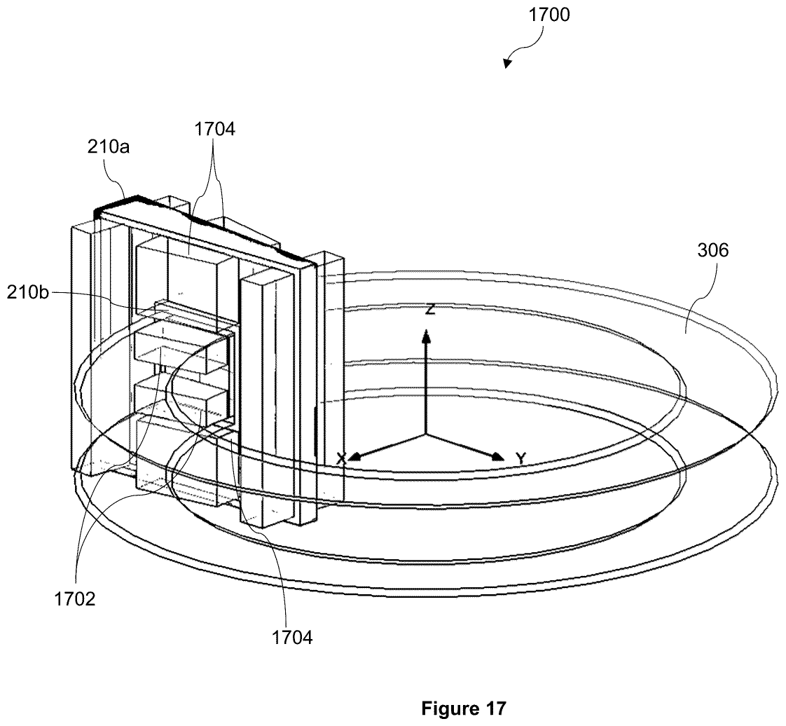

In an exemplary embodiment, FIG. 17 depicts an isometric view of an exemplary embodiment of the one or more petal units 202 of a sixteenth configuration 1700 comprising two or more co-planar coils (210a and 210b) bounding the inner edges and outer edges of the one or more magnetic cores 206 of the annular cross-section. The one or more coils 210 are connected in one of: the series configuration and the parallel configuration to the power source 204. The inner co-planar coil 210b of the one or more coils 210 may optionally enclose the hollow inner ferromagnetic toroid 306 containing one or more third pairs of magnets 1702 associated with the one or more pairs of magnets 208 located along the upper edges and lower edges of the inner co-planar coil 210b with the like poles oriented towards either face of the sandwiched magnetic core 1706 of the one or more magnetic cores 206. An additional pair of magnets 1704 may optionally be located along the upper edges and lower edges of the outer co-planar coil 210a of the one or more coils 210 with the like poles oriented into the one or more magnetic cores 206 of the annular cross-section.

Various embodiments are possible but not explicitly listed with permutations of the presence or absence of the one or more pairs of magnets 208 along one of: the outer co-planar coil 210a, the inner co-planar coil 210b, their pole orientations and shape variations in a ferromagnetic material, current directions, and the like. For instance, three alternative embodiments are based on the inner toroidal core being hollow, solid, and discontinuous in the form of arc segments with the air gaps separating each petal unit 202 of the one or more petal units 202 instead of a continuous toroidal ring of the one or more toroidal rings (102 and 104). In another embodiment with opposite current direction in the two or more co-planar coils (210a and 210b), the poles of the one or more third pairs of magnets 1702 are inverted relative to the one or more pairs of magnets 208 located outside the inner co-planar coil 210b. An alternative embodiment comprises a pair of ring magnets disposed on either side optionally at a distance from the one or more magnetic cores 206 of annular cross-section.

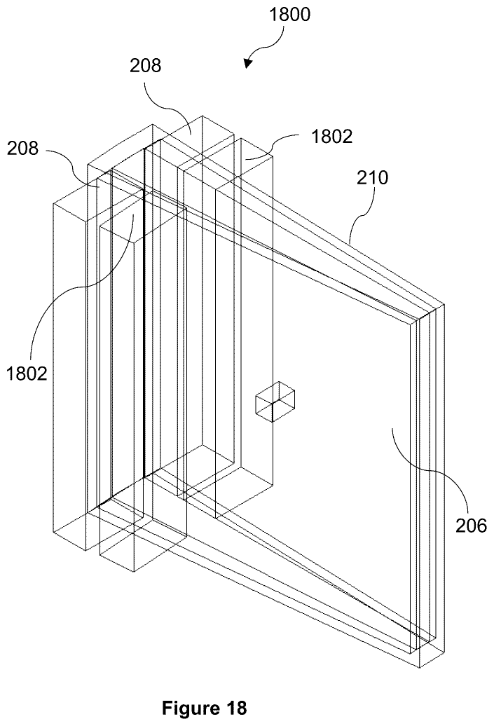

In an exemplary embodiment, FIG. 18 depicts an isometric view of an exemplary embodiment of the one or more petal units 202 of a seventeenth configuration 1800 comprising the one or more pairs of magnets 208 positioned at one end of the one or more coils 210 that are farther from the centre of the one or more rotors 108, with the like poles oriented towards opposite faces of the one or more magnetic cores 206 of the annular cross-section. An additional pair of magnets 1802 of the one or more additional pair of magnets may be positioned at specific locations between two opposite edges of the one or more coils 210.

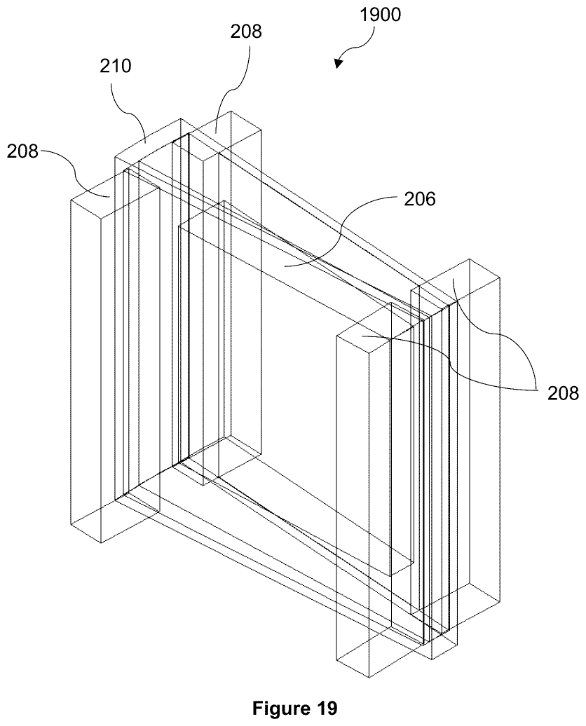

In an exemplary embodiment, FIG. 19 depicts an isometric view of an exemplary embodiment of the one or more petal units 202 of an eighteenth configuration 1900 wherein the one or more magnetic cores 206 of the annular cross-section are aligned asymmetrically relative to the centre of the one or more coils 210 along its axis. Each magnet 208 may be positioned at different offsets from the surface of the one or more magnetic cores 206.

Various alternative embodiments are possible but not explicitly listed having permutations of presence or absence of the one or more pairs of magnets 208 along two or more opposite edges of the one or more coils 210, situated either within or outside the one or more coils 210. The shape of the one or more pairs of magnets 208 may also vary with one of: the polygonal cross-sectional shape of the solid and optionally hollow ferromagnetic cores and the one or more coils 210.

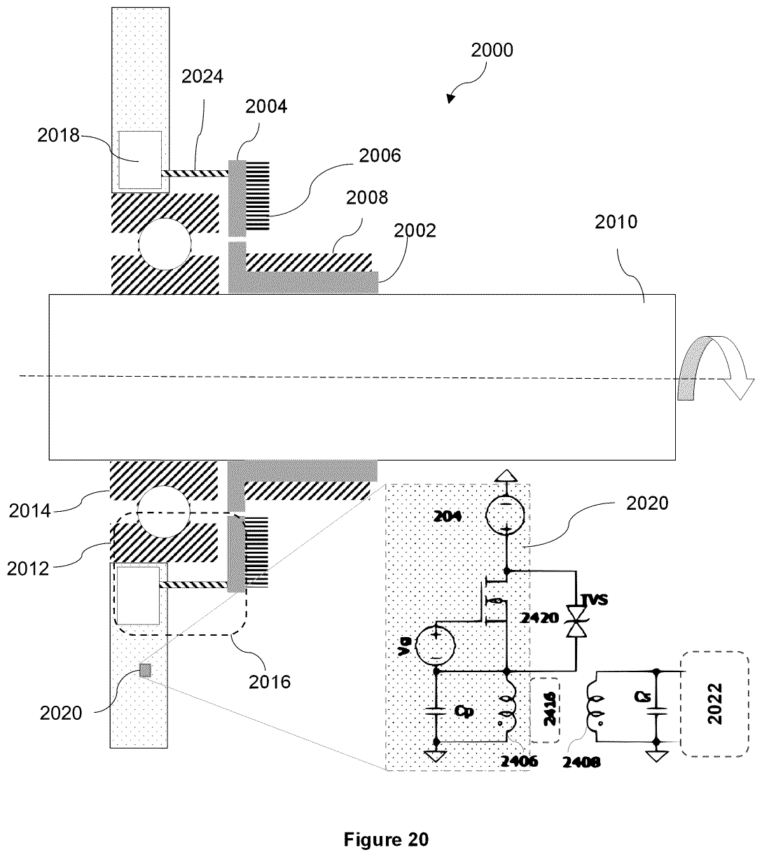

In an exemplary embodiment, each rotor 108 of the one or more rotors 108 is configured with a defined configuration of variable reluctance mechanism 2016 for inductive power transfer (IPT) to receive electric current from the power source 204. FIG. 20 depicts a detailed view of an exemplary embodiment of the statorless electromechanical device 100, highlighting an inductive power transfer (IPT) mechanism 2000 from the power source 204 located external to the one or more rotors 108. One or more primary coils 2006 associated with the one or more coils 210 are magnetically coupled at a non-unity coupling factor to corresponding one or more secondary coils 2008 associated with the one or more coils 210 wound on an optional ferromagnetic tube 2002 with a flange at one end. The one or more primary coils 2006 are either attached to the stationary outer surface of first bearings 2012 or to a stationary motor housing and do not rotate. The one or more secondary coils 2008 are attached to the rotary face of second bearings 2014. While other polygonal shapes are in scope for embodiment and alternatives, the preferred embodiment may contain one or more planar primary coils 2006 (transmitter) associated with the one or more coils 210 with circular, rectangular, and pentagonal cross-sectional mutually coupled via a ferromagnetic tube 2002 with helical one or more secondary coils 2008. Also shown is a zoomed-in inset of one embodiment of a switching sub-circuit 2020 between the one or more primary coils 2006 and the power source 204. Each coil 210 of the one or more coils 210 at each of primary sides and secondary sides is configured with one-to-one or one-to-many correlations with the one or more petal groups. Each coil 210 is connected electrically in parallel along with one or more compensation capacitor banks in a manner that electrically connected one or more coils 210 within each of the primary sides and the secondary sides have a high degree of inductive coupling. The one or more secondary coils 2008 are optionally of bifilar winding so that one end of a first wire is connected to a second wire at the opposite end of a helix in the configuration. The one or more primary coils 2006 and the one or more secondary coils 2008 may have one of: circular cross section and polygonal cross section.

A variable reluctance mechanism 2016 is described that impacts mutual induction between the one or more primary coils 2006 and the one or more secondary coils 2008. The ferromagnetic tube 2002 is fastened to an inner shaft 2010 made of high carbon steel such as steel 52100 or alternatives. The one or more primary coils 2006 are attached to the stationary side of the first bearings 2012 at a fixed distance from the motor housing with a small radial air gap between its inner diameter and rotary ferromagnetic flange. An optional ferromagnetic plate 2004 is mounted with an adjustable air gap from the one or more primary coils 2006 of similar shape. Varying the air gap results in varying the inductive coupling factor between the one or more primary coils 2006 and the one or more secondary coils 2008.

In one exemplary embodiment 2500 (not shown) the ferromagnetic plate 2004 adjacent to the one or more primary coils 2006 is configured with one or more pairs of holes with helical threads and is mounted on one or more pairs of screws 2024 with threads in opposite directions, each driven by one or more servos 2018 rotating in opposite directions situated within the motor housing. In an alternative IPT embodiment, the ferromagnetic plate 2004 is solid without the one or more pairs of holes and is fixed to one or more nuts into which the one or more screws 2024 are mounted. In another alternative IPT embodiment, the ferromagnetic plate 2004 is replaced by a mesh. In another alternative IPT embodiment, the ferromagnetic plate is replaced by radial ferromagnetic bars at the equal angular intervals along one or more concentric ferromagnetic rings associated with the one or more toroidal rings (102 and 104). In another alternative IPT embodiment, radial ferromagnetic bars are replaced by radially oriented chevrons.

Other mechanisms using one of: a lead screw, a worm gear, a belt, a rack, a pinion, and alternatives are employed to achieve translation of the ferromagnetic plate 2004 are within the scope of embodiments of this disclosure. Embodiments that use either screw or worm gear for rotation to translation conversion are configured with helical threads with a self-locking lead angle. In another alternative IPT embodiment, one or more servos 2018 are located external to the motor housing and connected to an external power source. Another alternative IPT embodiment excludes a pair of servos 2018 of the one or more servos 2018 but retains other components of the lead screw based embodiment 2500. This allows for manual adjustments using a tool such as a screwdriver to rotate the lead screw and is intended for applications where relatively rare coupling factor adjustment is made which is typical in constant torque applications or use cases that have size, cost, or other constraints.

The architecture and working of the IPT mechanism 2000 in this disclosure which will be described in more detail differs from prior art IPT designs. As the one or more petal groups may be switched on and off sequentially for dynamic torque control corresponding one or more primary IPT coils and the one or more secondary IPT coils are switched accordingly. This reduces copper losses by using minimal copper length from the power source 204 to the one or more coils 210 particularly at higher speeds when additional one or more coils 210 are switched off.

In an exemplary embodiment, the controller 112 commands the one or more servos 2018 to change the separation between the ferromagnetic plate 2004 and the one or more primary coils 2006 by a specified amount resulting in variation of reluctance of magnetic flux pathways between the one or more primary coils 2006 and the one or more secondary coils 2008 and also between the one or more primary coils 2006. It may be noted that the controller 112 is either a module within or a separate controller governing the IPT mechanism 2000.

Inductively coupled primary tank circuits and secondary tank circuits include one or more inductors and a compensating capacitor connected in parallel or in series-parallel configuration with a capacitor in series with an inductor-capacitor parallel pair. Additional filter capacitors may be used depending on application tolerance for harmonic distortion. The primary circuit connects to a switching sub-circuit 2020 that connects to the power source 204. Output from the one or more secondary coils 2008 is rectified and fed to the one or more petal units 202 in the one or more rotors 108. Impedance matching network at the primary circuits and the secondary circuits and a rectifier stage 2022 to convert Alternating Current (AC) to DC which is then fed to one or more DC loads are required and are well known in the art. In an alternative IPT embodiment, the primary tank circuit is connected to an inverter, and the rectifier is connected to a mains AC power supply.

In one embodiment of the IPT circuit, the primary side switching sub-circuit is self-switching at dynamic frequency where two electronic switching elements such as the MOSFET in an astable multivibrator configuration are switched at the primary LC tank's resonant frequency. This embodiment excludes external devices such as micro-controllers to drive MOSFET gate switching which brings down cost and complexity of varying frequency with load. The self-switching embodiment is also a special case of a symmetric operating frequency of both the primary tank circuits and the secondary tank circuits wherein the sizing of secondary tank components matches that of the primary and a compensating capacitor establishes the base resonant operating frequency. As the one or more petal groups are switched on or off resulting in DC load variance, corresponding inductively coupled coils in primary and secondary circuits are switched accordingly resulting in a change in operating frequency. It may be noted that effective inductance of the secondary tank with ‘n’ connected parallel coils each of intrinsic capacitance C, inductance L and mutual coupling coefficient k corresponding to n petal groups is expressed in Equation 2 and parasitic capacitance is nC.

$$\frac{[ 1 + k ( n - 1 ) ]}{n} L \qquad Equation 2$$

The astable multivibrator at the primary side dynamically changes its switching frequency due to the change in resonant frequency (expressed in Equation 3) resulting from a slight reduction in overall inductance (k≈1) and increase in capacitance. In this embodiment, efficiency & fraction of stored energy increases with increased quality factor (expressed in Equation 4) despite a fixed compensating capacitor, as more one or more coils 210 are switched on resulting in higher current circulating across the one or more coils 210 with reduced Equivalent Series Resistance (ESR).

$$\frac{{ω}_{0}}{\sqrt{1 + ( n - 1 ) k}} \qquad Equation 3$$

$${R}_{load} \sqrt{\frac{C}{L}} \qquad Equation 4$$

A switching rate in an embodiment is self-governing and dynamically changes to new resonant frequencies as the DC loads at the secondary side and mutual coupling from variable reluctance coupling mechanism 2016 changes. In an alternative IPT embodiment, the variable reluctance control mechanism 2016 is employed to change the coupling factor between the one or more primary coils 2006 and the one or more secondary coils 2008 conditionally linked to DC load variation and to change the output power level at the secondary.

In an alternative embodiment of the IPT circuit, inductively coupled to the one or more primary coils 2006 and the one or more secondary coils 2008 are compensated in asymmetric LC tank topologies that are differently sized at design time by a multiple 270, with the natural frequency of the primary LC tank being a specific multiple 270 of the natural frequency of the secondary LC tank. The value of the asymmetric natural frequency and component sizing multiple 270 is between 2 to 300 depending on the overall coil length that is small enough to be non-radiative, switching device capabilities, and application constraints on power output & efficiency. The primary side switching sub-circuit 2020 is configured with a single switching device such as, but not limited to, the MOSFET whose switching is controlled by a pulse generator including, but not limited to, an Operational Amplifier (Op-Amp), a microcontroller such as TMDSCNCD28379D, VCO or equivalent device known in the art, and the like, that generates voltage pulses at an optimal duty cycle and at a specific frequency depending on the natural frequency of the inductively coupled secondary circuit.

Embodiment optionally features runtime variation (mₙ_{ₚ}_{:n}_{ₛ}) of the static multiple 270 (m_{1:1}) by asymmetric switching of nₚ parallel connected coils at the primary tank having kₚ mutual coupling, and/or nₛ parallel connected coils at the secondary tank having kₛ mutual coupling as expressed in Equation 5.

$${m}_{{n}_{p} : {n}_{s}} = {m}_{1 : 1} \frac{\sqrt{1 + ( {n}_{s} - 1 ) {k}_{s}}}{\sqrt{1 + ( {n}_{p} - 1 ) {k}_{p}}} \qquad Equation 5$$

Embodiment achieves high power transfer at high switching efficiency and higher physical density wherein the primary tank circuit is switched at a much lower frequency than the natural frequency which is relatively high due to the fractional (1/multiple 270) size of inductor and compensating capacitance in the primary circuit which reduces overall volume and weight of the statorless electromechanical device 100. Leakage magnetic field (EMF) is also reduced due to the fractional (1/multiple 270) number of turns in the one or more primary coils 2006. This also reduces shield losses due to the lower primary inductance and thereby lower mutual induction in the shield. Controlled switching at a frequency much lower than the natural frequency of the primary tank minimises switching losses albeit at higher component cost compared to the self-switching variant. The inductor, the capacitor, the variable reluctance coupling mechanism 2016, and specific sizing multiple 270 between inductively coupled primary and secondary circuit components are replicated from embodiment.

In an alternative embodiment of the IPT circuit, the primary side switching sub-circuit may have one or more diodes optionally connected in parallel in the primary tank circuit and optionally between the power source 204 and tank to prevent reverse current and cause a periodic voltage buildup across the one or more primary coils 2006. All other components and core circuit design including multiple 270 and variable reluctance coupling mechanism 2016 are replicated from embodiment. At a specific coupling, multiple 270 and switching frequency that is within ±5% (depending on load) of the natural frequency of the secondary tank, the one or more primary coils 2006 in embodiment generate a half sinusoidal spike having the frequency multiple of the secondary tank's resonant frequency at the periodicity of the natural frequency of the secondary tank. The controller 112 adjusts separation between the primary side ferromagnetic plate and the one or more coils 210 to set an optimises coupling factor depending on the connected DC loads at secondary to be able to sustain resonant oscillations.

The operating frequency is generally unrestricted but is guided by standards depending on the area of application. For instance, the 85 kHz frequency band established by the popular SAE TIR J2954 standard is applicable for charging EVs. While IPT mechanisms and embodiments described in this disclosure are for power transfer to the one or more rotors 108, the same mechanism and design may be used to charge batteries by replacing the DC coils of the one or more coils 210 at the secondary circuit with a battery or a Battery Management System (BMS) that connects to and governs charging cycle of the battery.

In another embodiment of the IPT circuit, the primary side switching sub-circuit 2020 includes a push-pull dual switch configuration like in a flyback converter with an active clamp wherein each switch operates with mutual exclusivity with an optional dead time where both remain off for a duration to allow discharging parasitic capacitance to achieve zero voltage switching (ZVS) of the clamp switch in addition to other features of embodiment. Optionally one-way switches may be present in either circuit of inductively coupled primary and secondary coils with opposed coupling. While the mechanism of this embodiment is like that of embodiment, half the spike inductively couples to the secondary tank and sustains resonant oscillation while the other half is stored in the capacitor for reuse at the next cycle.

It may be noted that the IPT mechanism 2000 described in this embodiment and embodiments differ from prior art motors using WPT such as SRMs or alternative designs using the DC coils to generate static magnetic poles in the one or more rotors 108 that interact with time varying magnetic field in the stator via the air gap. Speed and torque control in prior art motors is achieved using Variable Frequency Drive (VFD) by varying frequency and Root Mean Square (RMS) voltage of the generated time varying signal.

In another alternative embodiment of the statorless electromechanical device 100, the open end of the one or more coils 210 from each petal unit 202 of the one or more petal units 202 is connected to one electrical brush terminal on one side of the central electrically conductive shaft. The other end of each coil 210 is connected via an electronic switching circuit to an electric brush located on the central shaft at the other side of the one or more rotors 108. This topology may be extended to connect more than one coil 210 inside the petal unit 202 in series so that a single electronic switch can control a group of petal units 202 of the one or more petal units 202. Each toroidal ring (102 and 104) assembly is electrically connected to the central shaft in this manner. The one or more rotors 108 may comprise one or more concentric toroidal ring assemblies where switching of one or more groups of coils 210 may be dynamically controlled using optimisation algorithmic models that are well known in the art.

In an exemplary embodiment, the statorless electromechanical device 100 produce smooth rotation and significantly reduce oscillations, vibrations, cogging, hysteresis, and noise thereby achieving higher durability and lower failure of structural parts such as the motor shaft, armature, and the like. The housing for the power source 204 may optionally be made of one of: magnetic shielding and ferromagnetic material optionally surrounded with elastic shock absorbing material to absorb mechanical impact and for tight packing.

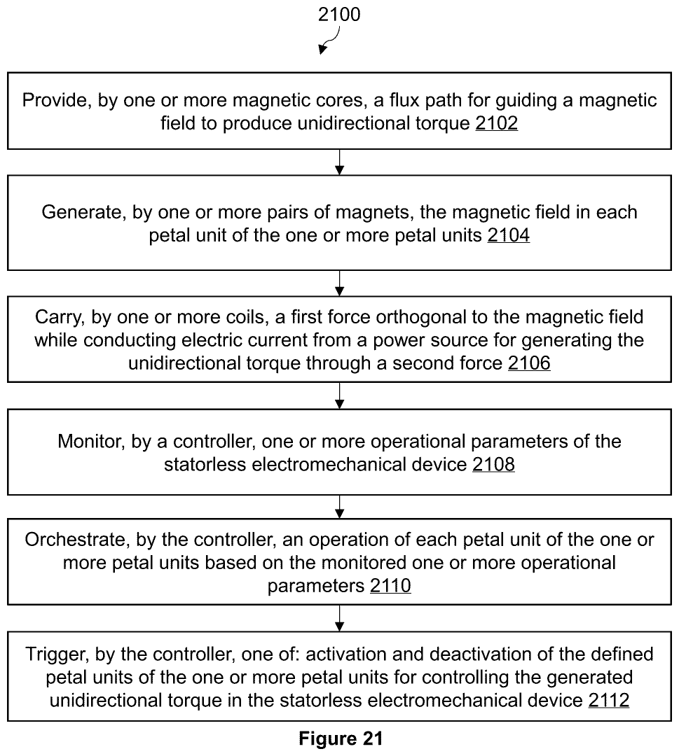

FIG. 21 illustrates an exemplary flowchart depicting a method 2100 for operating the statorless electromechanical device 100, in accordance with an embodiment of the present disclosure.

According to an exemplary embodiment of the disclosure, the method 2100 for operating the statorless electromechanical device is disclosed. At step 2102, the method 2100 involves the provision of the flux path by the one or more magnetic cores, which are strategically configured to guide the magnetic field. The magnetic field interaction is crucial for generating the unidirectional torque necessary for efficient statorless electromechanical device operation. At step 2104, the method 2100 includes the one or more pairs of magnets in each petal unit to produce the magnetic field. At step 2106, the method 2100 includes the magnetic field that interacts with the electric current supplied through the one or more coils. The one or more coils, carrying the electric current from the power source, create the first force orthogonal to the magnetic field to produce the unidirectional torque via the second force.

At step 2108, the method 2100 employs the controller to monitor and manage the one or more operational parameters of the statorless electromechanical device. At step 2110, the method 2100 employs the controller to dynamically orchestrate the operation of each petal unit based on the monitored one or more operational parameters, ensuring the statorless electromechanical device operates optimally under varying load and environmental conditions. At step 2112, the method 2100 employs the controller that triggers one of: the activation and the deactivation of the one or more petal units as required, enabling precise control over the generated unidirectional torque. This adaptive functionality allows the statorless electromechanical device to achieve high efficiency and reliability, making the statorless electromechanical device well-suited for applications requiring robust torque management and energy optimization.

A description of an embodiment with several components in communication with each other does not imply that all such components are required. On the contrary, a variety of optional components are described to illustrate the wide variety of possible embodiments of the disclosure. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the following claims.

What is claimed is:

1. A statorless electromechanical device, comprising:
one or more rotors, each rotor of the one or more rotors comprise at least one of:
one or more toroidal rings operatively positioned along a shared rotational axis of a bud unit, configured to provide a mounting structure for torque generation elements;
one or more petal units operatively positioned in each toroidal ring of the one or more toroidal rings and the bud unit, each petal unit of the one or more petal units comprise at least one of:
one or more magnetic cores operatively positioned inside each toroidal ring of the one or more toroidal rings and the bud unit, configured to provide a flux path for guiding magnetic field to produce a unidirectional torque;
one or more non-magnetic sheets of defined profile positioned asymmetrically on at least one side of each magnetic core of the one or more magnetic cores;
one or more pairs of magnets operatively positioned on either side of each magnetic core of the one or more magnetic cores, configured to generate the magnetic field; and
one or more coils wound around one of: an outer periphery and an inner periphery of each magnetic core of the one or more magnetic cores and operatively connected to a power source, configured to carry a first force orthogonal to the magnetic field while conducting electric current for generating the unidirectional torque through a second force; and
a controller operatively connected to each petal unit of the one or more petal units, configured to:
monitor one or more operational parameters of the statorless electromechanical device;
orchestrate an operation of each petal unit of the one or more petal units based on the monitored one or more operational parameters; and
trigger one of: activation and deactivation of defined petal units of the one or more petal units for controlling the generated unidirectional torque in the statorless electromechanical device.

2. The statorless electromechanical device of claim 1, wherein each rotor of the one or more rotors is configured with a defined configuration of variable reluctance mechanism for inductive power transfer to receive the electric current from the power source.

3. The statorless electromechanical device of claim 1, wherein the one or more toroidal rings are configured to be stacked at least one of: concentric arrangement and cylindrical arrangement based on application of the unidirectional torque,
the one or more toroidal rings are configured with one of: a rectangular hollow cross-section, a polygonal hollow cross-section, and a curved hollow cross-section and equipped with at least one of: homogeneous petal units of the one or more petal units and heterogeneous petal units of the one or more petal units.

4. The statorless electromechanical device of claim 1, wherein the one or more petal units are positioned at one of: angular intervals and angular offset relative to a radial line, along a circumference of each toroidal ring of the one or more toroidal rings and the bud unit.

5. The statorless electromechanical device of claim 1, wherein the one or more petal units are configured to operate in a phased activation sequence to trigger adjacent petal units of the one or more petal units sequentially to the avert torque ripple between the adjacent petal units.

6. The statorless electromechanical device of claim 1, wherein each magnetic core of the one or more magnetic cores is configured as one of: a polygonal solid magnetic core and an annular polygonal magnetic core,
the polygonal solid magnetic core is configured to:
enhance magnetic flux concentration oriented radially along the shared rotational axis;
direct the magnetic flux to a region of the one or more coils adjacent to the one or more magnetic cores; and
wherein the magnetic flux is oriented radially inward on one or more coils and is radially outward on the symmetrically opposite section of the one or more coils, to optimize the unidirectional torque; and
the annular magnetic core operatively positioned one of: the outer periphery and the inner periphery of the one or more magnetic cores radially, and tangential to the shared rotational axis,
each magnetic core of the one or more magnetic cores is configured with at least one of: a hollow inner ferromagnetic toroid, an inner core toroidal segment, alternating toroidal core segments with at least one core segment situated inside the one or more coils.

7. The statorless electromechanical device of claim 1, wherein each pair of magnets of the one or more pairs of magnets is positioned on symmetrically opposite sides of each magnetic core of the one or more magnetic cores, with like poles directed towards the one or more magnetic cores to generate magnetic flux oriented radially along the shared rotational axis in opposite directions across symmetrically opposite sections of the one or more coils; and
the position of each pair of magnets of the one or more pairs of magnets optimize the magnetic flux interactions with the one or more coils.

8. The statorless electromechanical device of claim 1, wherein the statorless electromechanical device comprises one or more additional pair of magnets,
the one or more additional pair of magnets are operatively positioned at an offset from the pair of magnets at a defined distance from a centre of the one or more magnetic cores with like poles directed towards the one or more magnetic cores.

9. The statorless electromechanical device of claim 1, wherein the one or more coils are configured to:
operate in a series configuration to produce an optimal voltage for one or more applications requiring a first range of the unidirectional torque; and
operate in a parallel configuration to an optimal current for the one or more applications requiring a second range of the unidirectional torque.

10. The statorless electromechanical device of claim 1, wherein the one or more operational parameters comprise at least one of: a load, rotational speed, temperature, current rating, and target unidirectional torque.

11. The statorless electromechanical device of claim 1, wherein the controller is configured with operational instructions to produce one of: a continuously variable torque and a stepwise variable torque based on triggering one of: the activation and the deactivation of at least one of: the homogeneous petal units of the one or more petal units and the heterogeneous petal units of the one or more petal units.

12. The statorless electromechanical device of claim 1, wherein the statorless electromechanical device is configured to operate in one of: a motor mode and a generator mode.

13. The statorless electromechanical device of claim 1, wherein the first force is electromagnetic force, and the second force is Lorentz force.

14. A method for operating a statorless electromechanical device, comprising:
providing, by one or more magnetic cores, a flux path for guiding a magnetic field to produce unidirectional torque;
generating, by one or more pairs of magnets, the magnetic field in each petal unit of the one or more petal units;
carrying, by one or more coils, a first force orthogonal to the magnetic field while conducting electric current from a power source for generating the unidirectional torque through a second force;
monitoring, by a controller, one or more operational parameters of the statorless electromechanical device;
orchestrating, by the controller, an operation of each petal unit of the one or more petal units based on the monitored one or more operational parameters; and
triggering, by the controller, one of: activation and deactivation of the defined petal units of the one or more petal units for controlling the generated unidirectional torque in the statorless electromechanical device.
